(19) United States
(12) Patent Application Publication
(10) Pub. No.: US 2009/0097170 A1
(43) Pub. Date: Apr. 16, 2009

(54) FERROMAGNETIC TUNNEL JUNCTION ELEMENT, MAGNETIC RECORDING DEVICE AND MAGNETIC MEMORY DEVICE

(75) Inventors: Masashige Sato, Kawasaki (JP); Shinjiro Umehara, Kawasaki (JP); Takahiro Ibusuki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/202,789

(22) Filed: Sep. 2, 2008

(30) Foreign Application Priority Data
Oct. 16, 2007 (JP) 2007-269422

(51) Int. Cl. G11B 5/33

(52) U.S. Cl. 360/324.12; G9B/5.104

(57) ABSTRACT

A ferromagnetic tunnel junction element is a magnetoresistance effect element wherein an electric resistance varies in accordance with a magnetic field applied. The ferromagnetic tunnel junction element includes a pinned layer wherein at least a part of a magnetization direction is held, and an insulation layer formed on the pinned layer, creating an energy barrier that electrons can flow through by a tunnel effect. A first free layer made of a first ferromagnetic material containing boron atoms, is formed on the insulation layer. In the first free layer, a direction of the magnetization switches under an influence of an external magnetic field. A second free layer made of a first ferromagnetic material containing boron atoms, is formed on the first free layer. The direction of magnetization of the second free layer switches under the influence of the external magnetic field, exchanging and coupling with the first free layer.

### BACKGROUND OF THE INVENTION

1. Field of the Invention

This invention relates to a ferromagnetic tunnel junction element that is a magnetoresistance effect element wherein an electric resistance varies in accordance with a magnetic field applied.

2. Description of the Related Art

A ferromagnetic tunnel junction element has a ferromagnetic metal/insulation layer/ferromagnetic metal-structure and an insulation layer thereof that produces an energy barrier that electrons can penetrate by the tunnel effect. In this specification, “/” means “and”. For the ferromagnetic tunnel junction element, a tunnel probability (tunnel resistance) depends on magnetization states of upper and lower magnetic layers. This means that the tunnel resistance can be controlled by controlling the magnetization states of the ferromagnetic metals by applying an external magnetic field. Typically, the ferromagnetic tunnel junction element has a pinned layer/insulation layer/free layer-structure. The insulation layer is sandwiched between the pinned layer, which is not susceptible to the external magnetic field, and the free layer, in which the direction of magnetization is readily toggled under the influence of the external magnetic field.

For the ferromagnetic tunnel junction, a tunnel magnetoresistive (TuMR) effect brings a higher magnetoresistive change ratio (MR ratio) than an anisotropic magnetoresistive (AMR) effect and a giant magnetoresistive (GMR). For this reason, a magnetic head applying the ferromagnetic tunnel junction element is expected to be an effective tool for a magnetic recording/reproduction with higher resolution (refer to Japanese Patent No. 2871670).

For instance, the ferromagnetic tunnel junction element having a Fe/MgO/Fe-layered body, in other words, an insulation layer made of magnesia oxide and ferromagnetic layers made of single crystal Fe has been presented (refer to nonpatent literature 1; Yuasa et al., Nature Materials vol. 3, 2004, p. 868-p. 871). There is a known problem that such a ferromagnetic tunnel junction element shows a high MR ratio, 200% and greater, at ambient temperatures. Since the ferromagnetic tunnel junction element a part of which is made of MgO produces specifically a large amount of reproduction output, it has been expected to be a desired material for the magnetic head, etc.

For the ferromagnetic tunnel junction element whose insulation layer is made of MgO, CoFe or CoFeB is used for contact of the free layer. In terms of the MR ratio, CoFeB drives a greater change in resistance by an external magnetic field at a particular intensity than CoFe. However, where the free layer of the ferromagnetic tunnel junction element is constructed into a single-layered structure, the coercivity tends to be greater, which makes the soft magnetic property inferior. This brings a problem such that—if applying the weak external magnetic field, the direction of the magnetization of the free layer does not switch, and therefore the resistance cannot be changed. To deal with this problem, a layer with a high soft magnetic property such as a NiFe layer is usually formed on a CoFeB layer.

However, depositing the layer with the high soft magnetic property impedes the MR ratio significantly compared to the case where the layer is not formed. This impediment becomes more pronounced with CoFeB. From a practical viewpoint, currently, the MR ratio is required to be 60% or greater where the tunnel resistance is 3Ωμm². However, with the junction structure wherein the layer with the high soft magnetic property is formed on the free layer, such MR ratios are unachievable.

Accordingly, an object of this invention is to provide a ferromagnetic tunnel junction element with a high MR ratio, wherein the magnetization direction of the free layer can be readily changed under the influence of the external magnetic field.

### SUMMARY

In accordance with an aspect of an embodiment, a ferromagnetic tunnel junction element includes a pinned layer wherein at least a part of a magnetization direction is held, an insulation layer formed on the pinned layer, creating an energy barrier that electrons can flow through by a tunnel effect, and a first free layer formed on the insulation layer made of a first ferromagnetic material containing boron atoms. The direction of magnetization of the first free layer switches under an influence of an external magnetic field. A second free layer is formed on the first free layer. The direction of magnetization of the second free layer switches under the influence of the external magnetic field, exchanging and coupling with the first free layer. The second free layer is made of a second ferromagnetic material containing boron atoms.

### BRIEF DESCRIPTION OF THE DRAWINGS

FIG. 1A and FIG. 1B show a sectional diagram and a plan view of the ferromagnetic tunnel junction element in a first example of this invention, respectively.

FIG. 2 shows an example of the XRD diffraction of a crystal layer deposited on a substrate.

FIG. 3A and FIG. 3B are sectional diagrams showing a production method of an example of a ferromagnetic tunnel junction element.

FIG. 4 is a sectional diagram showing an exemplary head slider having a magnetic head that is suitable for the ferromagnetic tunnel junction element, levitating above a magnetic recording medium.

FIG. 5 is a sectional diagram showing part of the head slider shown in FIG. 4.

FIG. 6 is a diagram showing part of a magnetic recording device having the magnetic head having the ferromagnetic tunnel junction element in the example.

FIG. 7A is a sectional diagram showing a magnetic random access memory (MRAM) applying the ferromagnetic tunnel junction element in the example and FIG. 7B is an equivalent circuit schematic thereof.

FIG. 8 illustrates a measuring method of the MR ratio.

FIG. 9 shows a magnetoresistive curve of the ferromagnetic tunnel junction element in the first example.

### DETAILED DESCRIPTION OF THE EXAMPLES

A ferromagnetic tunnel junction element in this invention can include a pinned layer wherein the magnetization direction is held in a specific direction. An insulation layer is formed on the pinned layer, creating an energy barrier that electrons can flow through by the tunnel effect. A first free layer is formed on the insulation layer, wherein the magnetization direction switches under an influence of an external magnetic field. The first free layer is made of a first ferromagnetic material containing boron atoms and a second free layer is formed on the first free layer, wherein the magnetization direction switches under the influence of the external magnetic field, exchanging and coupling with the free layer. The second free layer is made of a second ferromagnetic material containing boron atoms.

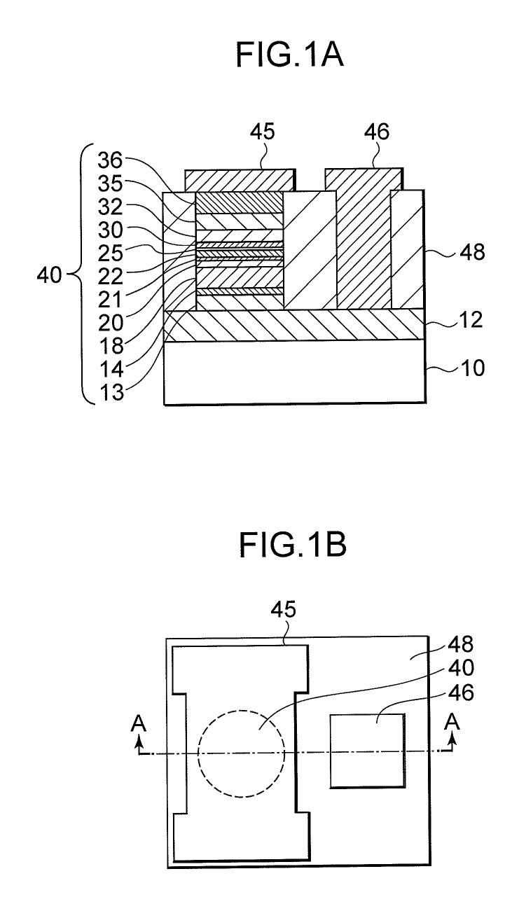

FIG. 1A and FIG. 1B are the sectional diagram and the plan view of the ferromagnetic tunnel junction element in the example of this invention, respectively. FIG. 1A is the sectional diagram of FIG. 1B sectioned at a dashed line 1A-1A.

As shown in FIG. 1A, a conductive layer 12 made of NiFe is formed on a Si support substrate 10 covered with a SiO₂ layer. As the material for the support substrate 10, a ceramic material such as AlTiC or silica glass can be substituted. A surface of the conductive layer 12 is leveled by the chemical mechanical polishing (CMP). On a part of the conductive layer 12, a ferromagnetic tunnel junction element 40 is formed cylindrically.

The ferromagnetic tunnel junction element 40 comprises, from bottom to top, a first underlayer 13, a second underlayer 14, a pinning layer 18, a first pinned layer 20, a nonmagnetic junction layer 21, a second pinned layer 22, an insulator layer (barrier layer) 25, a first free layer 30, a second free layer 32, a first cap layer 35 and a second cap layer 36.

The first underlayer 13 is made of Ta approximately 5 nm in thickness. The first underlayer 13 can be made of Cu or Au, or a layered body of Cu and Au. The second underlayer 14 is made of Ru approximately 2 nm in thickness.

The pinning layer 18 is made of IrMn approximately 7 nm in thickness. The pinning layer 18 can be made of other anitferromagnetic material, such as an alloy containing at least one element selected from among Pt, Pd, Ni, Ir, or Rh and Mn. A thickness of the pinning layer 18 is preferably within a range of 5-30 nm, and more preferably, within a range of 10-20 nm. After forming the pinning layer 18, a heat treatment is conducted to order the crystalline state therein, to obtain antiferromagnetism.

The first pined layer 20 is composed of 74 at % of Co atoms and 26 at % of Fe (Co₇₄Fe₂₆), and its thickness is defined as 2 nm here. In this specification, figures suffixed to the end of the atomic symbols indicate the ratios of atom amounts. E.g., where a chemical compound is composed of 74 at % of Co and 26 at % of Fe, it is expressed as Co₇₄Fe₂₆. The nonmagnetic junction layer 21 is made of Ru 0.8 nm in thickness in this example. The second pinned layer 22 is made of Co₆₀Fe₂₀B₂₀ and is approximately 2 nm in thickness. The magnetization direction of the first pinned layer 20 is held in a specific direction due to an exchange-coupling effect with the pinning layer 18. It means that the magnetization direction of the first pinned layer 20 does not switch by applying the external magnetic field if the external magnetic field is weaker than the magnetic field caused by the exchange-coupling effect. Between the first pinned layer 20 and the second pinned layer 22, the exchange-coupling occurs through the nonmagnetic junction layer 21.

A thickness of the nonmagnetic junction layer 21 is within a reasonable range in which the antiferromagnetic exchange-coupling can be induced between the first pinned layer 20 and the second pinned layer 22. The range is from 0.4 nm to 1.5 nm, optimally, 0.4 nm to 0.9 nm. The first pinned layer 20 and the second pinned layer 22 can be made of a ferromagnetic material containing any of Co, Ni, or Fe. The nonmagnetic junction layer 21 can be made of a nonmagnetic material such as Rh, Ir, Ru series alloy, Rh series alloy, or Ir series alloy instead of Ru. One of representative Ru series alloy is an alloy of at least one element selected from among Co, Cr, Fe, Ni or Mn and Ru.

Since the magnetization directions of the first pinned layer 20 and the second pinned layer 22 are in an anti-parallel state, an intensity of the effective leakage magnetic field leaked from the first and the second pinned layers 20 and 22 becomes lower. This curbs a negative effect of the leakage magnetic field that switches the magnetization directions of the first and the second free layers 30 and 32. Thereby the magnetizations of the first and the second free layers 30 and 32 can react to the leakage magnetic field from the magnetic recording medium, and the magnetization state of the magnetic recording medium can be detected more precisely.

The insulation layer 25 is made of MgO 1.0 nm in thickness. It is preferable that the constituent element of the insulation layer 25, MgO, is crystalline, more preferably, a (001) side of MgO is oriented parallel to the substrate. Here, the (001) indicates that (001) phase of a crystal lattice of MgO is oriented parallel to the substrate. A thickness of the insulation layer 25 is optimal within a range of 0.7-2.0 nm. The insulation layer 25 can be made of AlO₂, TiO₂, ZrO₂, AlN, TiN, ZrN instead of MgO. If the insulation layer 25 is made of a material other than MgO, a thickness thereof is preferably specified within a range of 0.5-2.0 nm, more preferably, within a range of 0.7-1.2 nm.

The first free layer 30 is made of Co₆₀Fe₂₀B₂₀, an amorphous ferromagnetic material, having a thickness of approximately 2 nm. To facilitate making the first free layer amorphous, the first free layer preferably contains B within a range of 12-24 at % in concentration. The ferromagnetic tunnel junction element wherein the first free layer 30 is made amorphous reportedly has a high MR ratio. The first free layer 30 can be made of a soft magnetic material and at least one element selected from among C, Al, Si, or Zr instead of CoFeB.

The second free layer 32 is made of Ni₇₂Fe₈B₂₀ 4 nm in thickness. The second free layer 32 is made of soft magnetic material that has a lower coercivity than that of the first free layer 30. As representative of the constituent elements of the second free layer 32, there are NiFe and CoNiFe. The second free layer 32 can be made of soft magnetic material and at least one element selected from among C, Al, Si, or Zr instead of NiFeB.

The typical structure of the ferromagnetic tunnel junction element is a pinned layer/insulation layer/free layer-structure wherein the insulation layer is sandwiched between the pinned layer and the free layer. As previously described, “/” means “and”. The pinned layer is an in-between layer of the ferromagnetic layer and the insulation layer, and a magnetization state in the contact zone thereof is not readily reversed under the influence of the external magnetic field. The pinned layer is a layer contacting the insulation layer, wherein the magnetization direction can be freely switched under the influence of the external magnetic field. The pinned layer includes the first pinned layer 20, the nonmagnetic junction layer 21 and the second pinned layer 22 in this example. The insulation layer includes the insulation layer 25. The free layer includes the first free layer 30 and the second free layer 32. The external magnetic field here is defined as a magnetic field that has a sufficient intensity to switch the magnetization state of the free layer, and is generally several tens of Oe (Oersted) or greater.

Here, the ferromagnetic tunnel junction is briefly described. For the ferromagnetic tunnel junction, the tunnel probability (tunnel resistance) depends on the magnetization states of the upper and lower magnetic layers thereon and thereunder. That means, the tunnel resistance can be controlled by the external magnetic field. Where a relative angle of the magnetization is θ, a tunnel resistance R is given by formula:

R=Rs+0.5ΔR(1−cos θ) (1)

Viz, where the directions of the magnetizations of both magnetic layers are in the one specific direction (θ=0), the tunnel resistance becomes lower (R=Rs). Adversely, where the magnetizations of both magnetic layers are oppositely oriented (θ=180 degree), the tunnel resistance becomes higher (R=Rs+ΔR).

Which is attributed to the fact that electrons in the ferromagnetic substance are polarized. Electrons are, generally, classified into two types: electron spins parallel (up-spin electron), and electron spins anti-parallel (down-spin electron). In the typical nonmagnetic metal, there are an equal number of both types of the electrons. Therefore, the magnetization within the nonmagnetic metal is neutralized. For the ferromagnetic material, the number of up-spin electrons (Nup) and the number of down-spin electrons (Ndown) are not equal, so that a magnetism therein is in either of an up-spin state or a down-spin state as a whole.

When tunneling, these electrons maintain their spin states when tunneling.

Therefore, if the electronic state of a tunneling destination is unoccupied, the electrons can be tunneled. If the electronic state is occupied, the electron cannot tunnel. The change ratio of the tunnel resistance can be expressed by a product of a polarizability of the electron source and a polarizability of the tunneling destination, by the following formula:

ΔR/Rs=2×P1×P2/(1−P1×P2) (2)

where

P1, P2: the polarizabilities of both magnetic layers

Thus the polarizabilities are given by formula:

P=2(Nup−Ndown)/(Nup+Ndown) (3)

The polarizability P depends on types of the ferromagnetic metal. E.g., the polarizabilities of NiFe, Co and CoFe are 0.3, 0.34 and 0.46 respectively. Thus the MR ratios are assumed as app. 20%, 26%, 54% respectively.

In this example, the ferromagnetic tunnel junction element can enhance its susceptibility to an external magnetic field (easiness to switch the magnetization direction of the free layer) by coupling the first free layer 30 and the second free layer 32 having a lower coercivity magnetically. Generally, the lower the coercitivity of the ferromagnetic layer is, the more susceptible to the external magnetic field the ferromagnetic layer is. Since the coercivity of the second free layer 32 is lower than that of the first free layer 30, when the direction of the external magnetic field changes, the magnetization direction of the second free layer 32 changes before the magnetization direction of the first free layer 30 changes. With the change of the magnetization direction of the second free layer 32, the magnetization direction of the first free layer 30 changes because exchange-coupling between the first free layer 30 and the second free layer 32 has occurred. Therefore, the magnetization direction of the first free layer 30 becomes more susceptible to the change of the external magnetic field. In short, since the magnetization direction of the first free layer 30 contributes to the MR ratio, forming the second free layer 32 enhances the response of the ferromagnetic tunnel junction element to the external magnetic field.

Again, the reason why the MR ratio of the ferromagnetic tunnel junction element in this example is improved is believed to be: 1). by including B (boron), the second free layer 32 has an amorphous structure. 2). Because of its amorphous structure, the second free layer 32 does not have a major impact on a chemical structure of the first free layer in a heat treatment conducted after forming the layers composing the ferromagnetic tunnel junction element in this example. 3). Thus the intrinsically high MR ratio of the ferromagnetic tunnel junction composed of—pinned layer/insulation layer/the first free layer containing boron atoms—is not likely to be reduced.

Where the second free layer does not contain B, the second free layer is a solid material having a crystal structure, in other words, a crystalline material. This crystalline material may affect the crystal structure of the first free layer in the heat treatment conducted after forming the layers of the ferromagnetic tunnel element. For instance, where the second free layer is made of Ni₈₀Fe₂₀, the second free layer is of a polycrystalline substance and a structure thereof is a fcc (111) structure. For the ferromagnetic tunnel junction wherein the second free layer is formed on the first free layer, the structure of the amorphous CoFeB of the first free layer could change to the fcc (111 ) structure under the influence of the fcc structure (111) of the second free layer in conducting the heat treatment. The ferromagnetic tunnel junction element wherein the free layer having (111) orientation is formed on the insulation layer is inferior in MR ratio.

The free layer composed of the ferromagnetic tunnel junction element in this example has the amorphous structure in which a fine crystalline material is contained. Where the first free layer 30 and the second free layer 32 is of the fine crystalline material, a decrease of the MR ratio can be curbed compared to the case where the free layers are made of the crystalline material.

For instance, when viewing a section of the tunnel junction element under a transmission electron microscope (TEM), if ordered crystal lattices can be observed in the first free layer 30 and the second free layer 32, the first free layer 30 and the second free layer 32 are of the crystalline materials. Where the ordered crystalline lattices are not observed, the first free layer 30 and the second free layer 32 are of the amorphous materials.

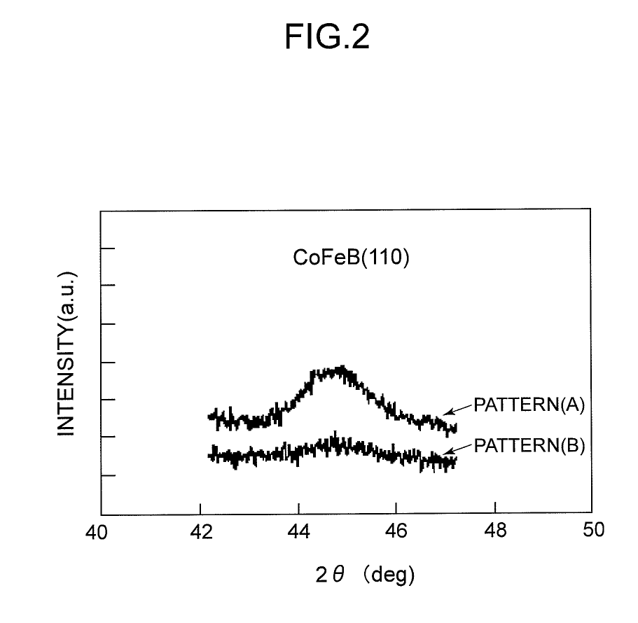

Again, when CoFeB in the first free layer 30 is analyzed by X-ray diffraction (XRD), i.e., the X-ray diffraction meter (0-20) method, if resultant pattern does not show any diffraction, the first free layer 30 is of the amorphous material. FIG. 2 shows an example of the XRD diffraction pattern resulting from an analysis of a crystalline layer deposited on a substrate. The crystalline layer is made of CoFeB(110)-oriented alloy. Pattern A shows a diffraction result of a crystalline layer containing 15 at % of boron atoms. Pattern B shows a diffraction result of a crystalline layer containing 10 at % of boron atoms. Pattern A is an example showing diffraction. Pattern B is an example showing little or no diffraction.

Being amorphous, the first and the second free layers preferably contain 10 at % or greater of boron atoms. Meanwhile, where the free layers contain too many boron atoms, the boron atoms may act as an impure substance, which may cause reduction of the polarizability and a decrease of the MR ratio. For that reason, the contained amount of boron atoms is preferably 25% or less.

For the first free layer 30, a region contacting with the insulation layer 25 can be crystallized. For instance, where the tunnel junction element has an insulation layer made of MgO (001) and the free layer is made of CoFeB, the first free layer is amorphous at the stage of forming the layers of the ferromagnetic tunnel junction element. However, in the heat treatment conducted thereafter, in general, an ultra-shallow surface of the contact of the first free layer with the (001) phase of MgO is recrystallized into CoFe (001) with the bcc structure under the influence of the crystal structure of the insulation layer. Owing to this recrystallized portion, tunnel current can flow. If most of the first free layer 30 is made of the amorphous material and/or fine crystalline material, the resistance ratio of the first free layer will be sufficiently higher than the case where the first free layer is made of CoFe. For the ferromagnetic tunnel junction in this invention, where the recrystallized portion of the first free layer is on the order of 0.5 nm in thickness, the first free layer can be considered amorphous as a whole.

Furthermore, a composition of CoFe in the first free layer (excluding B) is preferably invulnerable to external magnetic fields, in other words, a magnetostriction-resistant composition, because large magnetostriction weakens the magnetization, thus impairing the soft magnetic property. Therefore, the compounding proportion of Co atoms to Fe atoms is preferably 75 at % or less. However, the soft magnetic property can be adjusted by thickening the second free layer even where Fe atoms and Co atoms are equally composed. Thus the composition of CoFe in the first free layer is not specified.

For the composition of NiFe in the second free layer (excluding B), it is preferable have a larger amount of Ni atoms than Fe atoms in order to reduce the magetostriction to the first free layer.

The first cap layer 35 and the second cap layer 36 prevent oxidation of the ferromagnetic layer formed thereunder in the heat treatment or in using the element. The first cap layer 35 is made of Ta of 5 nm in thickness. The second cap layer 36 is made of Ru, of 10 nm in thickness. Alternatively, the first cap layer 35 can be made of Ru and the second cap layer 36 can be made of Ta. More commonly, the cap layers can be made of nonmagnetic metal such as Au, Ta, Al, W, Ru, or constructed into the layered structure composed of these metal layers. A thickness of the cap layer is preferably within the range of 5-30 nm.

A portion of the surface of the conductive layer 12 where the ferromagnetic junction element 40 is not formed thereon is covered with the insulation layer 48 made of insulation material such as SiO₂. A first electrode 45 is formed on the ferromagnetic tunnel junction element 40 and the insulation layer 48. The first electrode 45 is connected to the second cap layer 36 electrically. Avia hole leading to the conductive layer 12 is formed through the insulation layer 48, and a second electrode 46 is filled in the via hole, thereby connecting the second electrode 46 to the conductive layer 12 electrically. The first electrode 45 and the second electrode 46 are made of Cu.

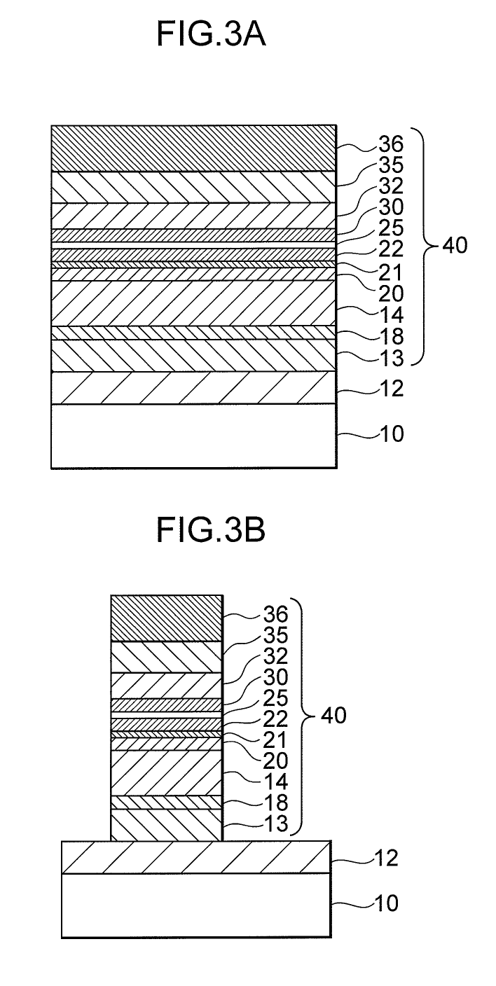

Next, referring to FIG. 3A and FIG. 3B, the production method of the ferromagnetic tunnel junction element in this example will be discussed.

As per FIG. 3A, on the support substrate 10, the conductive layer 12 through the second cap layer 36 are formed by a magnetron sputterer. Thereafter, the supporting substrate is treated with heat with the magnetic field applied in a vacuum state. With this heat treatment, the magnetizations of the first pinned layer 20 and the second pinned layer 22 are held in a specific direction. Moreover, the crystal orientation of the (001) phase of MgO composing the insulation layer 48 is specifically ordered and further the contact of the first free layer with the insulation layer is recrystallized. The heat treatment temperature is, e.g., 280 degree C. and the heat treating time is 4 hours here. The temperature of the heat treatment is preferable within the range of 250-350 degree C. Where the teat treatment temperature is not in excess of 250 degree C., the contact of the first free layer with the isolation layer is not likely to be recrystallized, thus reducing the MR ratio. If the temperature of the heat treatment exceeds 350 degree C., the magnetic property of the pinning layer is impaired, and thus the magnetization of the pinned layer is reversed by applying the external magnetic field, which may reduce the MR ratio.

As per FIG. 3B, the columnar ferromagnetic tunnel junction element 40 is formed by patterning from the first underlayer 13 to the second cap layer 36. For the patterning of these layers, Ar ion milling can be used. Thereafter, as per FIG. 1A, the insulation layer 48, the first electrode 45, the via hole penetrating the insulation layer 48, and then the second electrode 46 are formed.

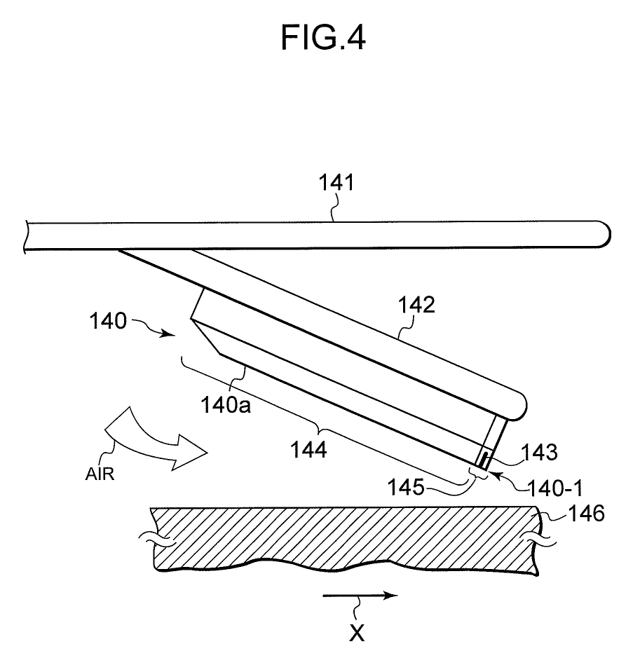

FIG. 4 is the sectional diagram illustrating the head slider having the magnetic head applying the ferromagnetic tunnel junction element in this example, levitating above the magnetic recording medium.

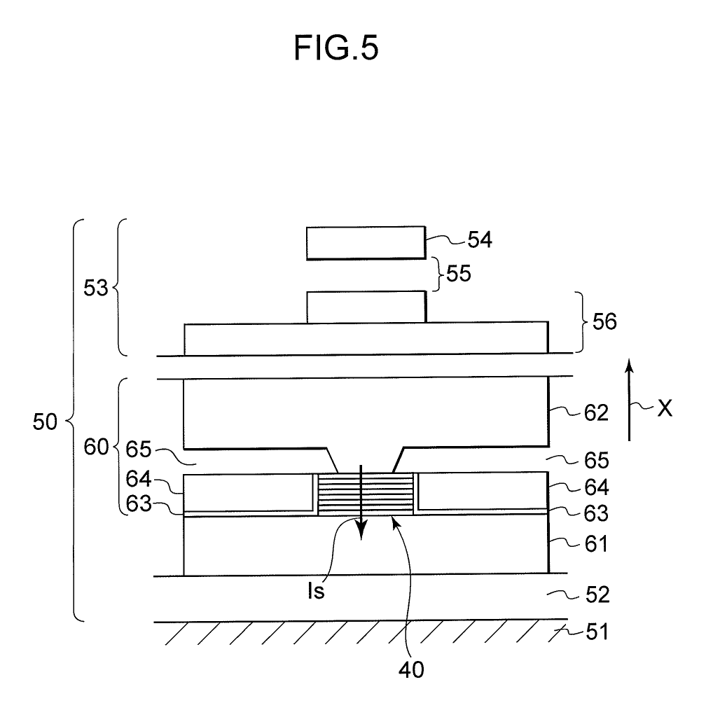

A head slider having an element pare 143. The element pare 143 comprises a head slider base 51 (FIG. 5) made o e.g., Al₂O₃—TiC, a magnetic head 50 for recording/reproducing information onto/from a magnetic recording medium 146 (FIG. 4). At the end of the surface 140a of the head slider 140 against the magnetic recording medium 146 (the surface facing to the medium), the magnetic head 50 is laid out in the vicinity of air ventilation 140-1, wherein an element part 143 comprising a reproduction element and a recording element later described with FIG. 5 are formed.

The head slider 140 is attached onto a gimbal 142 that is attached onto a plate-shaped suspension 141. The suspension 141 and the gimbal 142 are pivotally hinged by a spring.

The surface 140a facing the medium of the head slider 140 is lifted by a force for lift (upward force) caused by the air flow (indicated with “AIR” arrow in FIG. 4) flowing over the magnetic recording medium 146 rotating in an X direction (indicated with an arrow in FIG. 4). A downward force is applied by the suspension 141 supporting the head slider 140. The slider 140 is lifted by a predetermined lifting amount (a distance from the surface of the element part 143 to the surface of the magnetic recording medium 146) by a power balance of the upward force and the downward force. The element part 143 detects the leakage magnetic field from the recording layer of the magnetic recording medium (not illustrated).

FIG. 5 is a sectional diagram illustrating part of the head slider shown in FIG. 4. The magnetic head 50 includes the reproduction element 60 formed on the head slider base 51 made of Al₂O₃—TiC, and further includes a recording element 53 formed on the reproduction element 60, an alumina layer and a hydrogenerated carbon layer as necessary.

The recording element 53 has an upper electrode 54 whose width of surface against the medium is equivalent to a track width of the magnetic recording medium, a lower electrode 56 sandwiching a recording gap layer 55 made of nonmagnetic material with the upper electrode 54, a yoke (not illustrated) connecting the upper electrode 54 and the lower electrode 56 magnetically, a coil (not illustrated) winding around the yoke that induces a magnetic field for recording by current for recording. The upper electrode 54, the lower electrode 56 and the yoke are made of soft magnetic material with a high saturation magnetic flux density such as Ni₈₀Fe₂₀, CoZrNb, FeN, FeSiN, FeCo alloy to produce the magnetic field for recording. The recording element 53 is not limited to the one described above but also can be a recording element having a publically known structure. Further as an alternative, a recording element for the perpendicular magnetic recording having a main magnetic pole and an auxiliary magnetic pole can be used as the recording element 53. Again, the magnetic head 50 does not necessarily have the recording element 53.

The reproduction element 60 has the ceramic base 51, an insulation layer 52 made of alumina, formed on the ceramic base 51, a lower electrode 61, the ferromagnetic tunnel junction element 40, an insulation layer 65 made of alumina, and an upper electrode 62. The upper electrode 62 is connected to a surface of the ferromagnetic tunnel junction element 40 electrically. On the both sides of the ferromagnetic tunnel junction element 40, magnetic domain control layers 64 are formed, isolated by insulation layers 63 from the ferromagnetic tunnel junction element 40. The magnetic domain control layers 64 are of layered bodies constructed of, from bottom to top, a Cr layer and a ferromagnetic CoCrPt layer. The magnetic domain control layers 64 act to consolidate magnetic domains of the pinned layer 13, the first free layer 15 and the second free layer 18 comprising the ferromagnetic tunnel junction element shown in FIG. 1, preventing generation of Barkhausen noise.

The lower electrode 61 and the upper electrode 62 are made of soft magnetic alloy, e.g., NiFe or CoFe, in order to act as a magnetic shield to and function as a channel for sense current Is. Further, the conductive layer, e.g., a Cu layer, a Ta layer or a Ti layer can be formed between the lower electrode 61 and the ferromagnetic tunnel junction element 40.

The ferromagnetic tunnel junction element 40 is the ferromagnetic tunnel junction element in the example of this invention shown in FIG. 1. To avoid a repetition, the description of the ferromagnetic tunnel junction element 40 will be omitted. The sense current Is flows from, e.g., the upper electrode 62 through the ferromagnetic tunnel junction element 40 in a perpendicular direction to the lower electrode 61. The tunnel resistance value of the ferromagnetic tunnel junction element 40 varies in accordance with the intensity and the direction of the leakage magnetic field from the magnetic recording medium. The reproduction element 60 detects the change of the tunnel resistance value of the ferromagnetic tunnel junction element as a voltage shift. In the manner described above, the reproduction element 60 reproduces the information recorded on the magnetic recording medium. The direction in which the sense current Is flows is not limited to the direction indicated by the arrow shown in FIG. 5. Further, the rotating direction of the magnetic recording medium can be opposite.

The reproduction element 60 and the recording element 53 are coated with an alumina film, a hydrogenated carbon film or the like to prevent erosion.

Since the magnetic head 50 has the reproduction element 60 having the ferromagnetic tunnel junction element 40 with a high tunnel resistance changing ratio, the single-to-noise ratio (S/N ratio) is high. This enables the magnetic head 50 to detect signals with the high S/N ratio even where the leakage magnetic field from the magnetic recording medium is weakened due to the high recording density. Further, for the ferromagnetic tunnel junction element 40, the magnetizations of the first free layer 15 and the second free layer 18 are easily toggled by the weak external magnetic field. This high susceptibility of the magnetic head to the external magnetic field supports the high recording density.

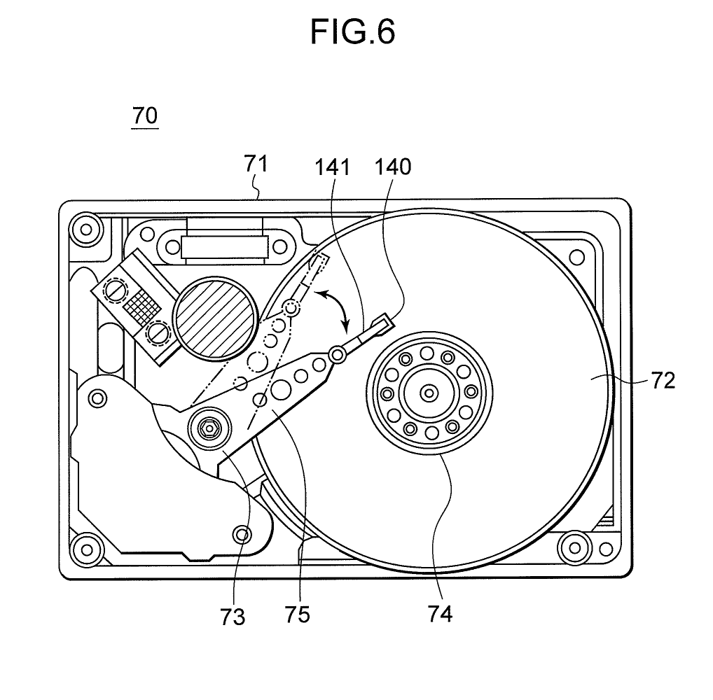

FIG. 6 is the pattern diagram showing the chief part of the magnetic recording device suited for the magnetic head having the ferromagnetic tunnel junction element in the example. A magnetic recording device 70 comprises a housing 71, a disk-shaped magnetic recording medium 72 loaded in the housing 71, the head slider 140, an actuator unit 73, etc. The magnetic recording medium 72 is fixed to a hub 74, and operated by a spindle motor (not illustrated). The head slider 140 has the magnetic head 145 (not illustrated). The head slider 140 is fixed to the end of the suspension 141, and the other end of the suspension 141 is fixed to an arm 75. The arm 75 is attached to an actuator unit 74. The head slider 140 is pivoted in a radius direction of a magnetic recording medium 62 by the actuator unit 74. On the back of the housing 71, an electronic substrate (not illustrated) for recording/reproduction control, magnetic head positioning and spindle motor control is formed.

The magnetic recording medium 72 can be a longitudinal magnetic recording medium wherein the easy axis of magnetization of the recording layer is oriented parallel to the surface of the recording layer. The longitudinal magnetic recording medium comprises, e.g., an underlayer made of Cr or Cr alloy, a recording layer made of CoCrPt alloy, a protective layer and a lubricant layer from bottom to top. The orientation of the easy axis of magnetization is held in parallel direction to the surface of the recording layer under the influence of the underlayer.

Alternatively, the magnetic recording medium 72 can be a perpendicular magnetic recording medium wherein the easy axis of magnetization of the recording layer is oriented perpendicular to the surface of the recording layer. The perpendicular magnetic recording medium comprises, e.g., from bottom to top, a substrate, a soft magnetic underlayer, an inner layer, a recording layer constructed of a perpendicular magnetization layer, a protective layer and a lubricant layer. The representative recording layer is made of, e.g., CoCrPt alloy with a ferromagnetic polycrystalline structure or CoCrPt—SiO₂ with a columnar granular structure. The orientation of the easy axis of magnetization of the recording layer becomes parallel to its surface spontaneously, or under the influence of the inner layer. For the perpendicular magnetic recording medium, the thermal stability of the magnetization recorded thereon is superior to that of the longitudinal magnetic recording medium, thus the higher recording density can be accomplished compared to the longitudinal magnetic recording medium.

Or, the magnetic recording medium 72 can be an obliquely oriented magnetic recording medium wherein the orientation of the easy axis of magnetization of the recording layer is inclined. The obliquely oriented magnetic recording medium can include, e.g., from bottom to top, a substrate, an underlayer made of Cr or Cr alloy, a recording layer made of CoCrPt alloy, a protective layer and a lubricant layer. The crystalline orientation of the underlayer is obliquely oriented to the surface. Under the influence of the underlayer, the orientation of the easy axis of magnetization of the recording layer is oblique to the surface. Since the magnetization direction of such recording layer can be reversed by a minor magnetic field for recording from the magnetic head, it is superior in recording property, i.e., recording performance. Owing to its superior recording performance, the obliquely oriented magnetic recording medium can achieve a higher recording density compared to the longitudinal magnetic recording medium and the perpendicular magnetic recording medium.

The head slider 140 has the magnetic head 145 (not illustrated). The reproduction element 60 of the magnetic head 145 has a high S/N ratio, which enables the magnetic recording device 70 to detect the leakage magnetic field leaked from the magnetic recording medium 72 even where the intensity of the leakage magnetic field is lowered due to the high recording density, and the S/N ratio of the detected signals is high. Thus, it can support high recording density.

The basic structure of the magnetic recording device 70 is not limited to the one shown in FIG. 6. Again, the shape of the magnetic recording medium 72 is not limited to a discoid. For instance, the magnetic recording medium 70 can be a helical scan/lateral type magnetic tape device. For the helical scan type, the magnetic head 40 is incorporated in a cylinder head, while for the lateral type, the magnetic head 40 is incorporated in a head block contacting on the magnetic tape when the magnetic tape runs in the longitudinal direction.

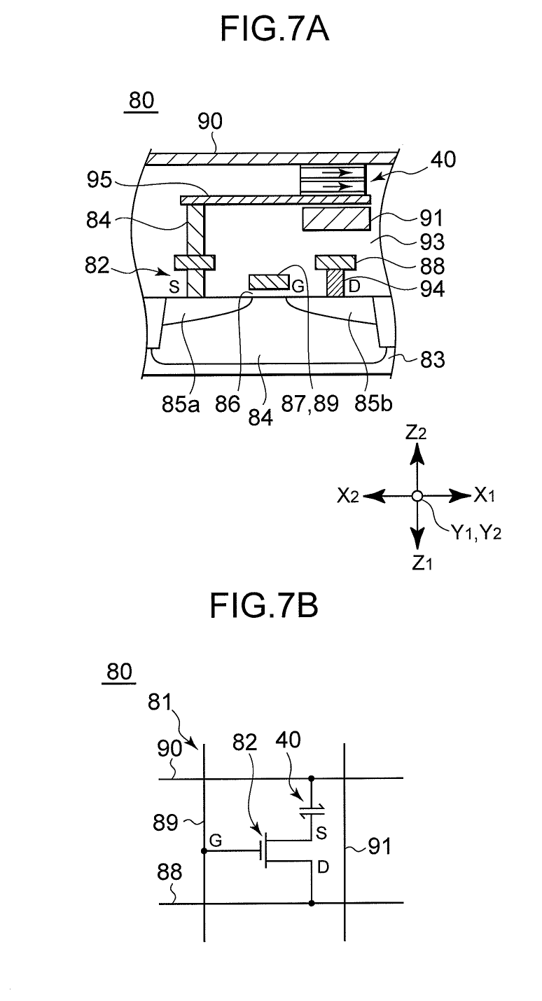

FIG. 7A is a sectional diagram of the MRAM employing the ferromagnetic tunnel junction element in the example. FIG. 7B is the equivalent circuit schematic of the MRAM. In FIG. 7A, orthogonal coordinates are shown for reference. Of the orthogonal coordinates, the Y1 direction and the Y2 direction are vertical to the sectional diagram. Hereinafter, the direction simply indicated as X direction means any of the X1 and/or X2 direction. Likewise, the Y and Z directions are referred to in the same fashion.

A magnetic memory device 80 comprises, roughly described, the ferromagnetic tunnel junction element 40 and a plurality of memory cells 81 composed of a MOS type field-effect transistor (FET) 82. As the MOS type FET, a P channel MOS type FET or a N channel MOS type FET can be used. As an example, the magnetic memory device 80 using the N channel MOS type FET wherein the electrons act as carriers will be discussed here.

The MOS type FET 82 has a P-well 84 containing p-type impurities formed in a silicon substrate 83. Impurity diffusion regions 85a and 85b are formed apart from each other at the near-surfaces of the p-well region 84 formed in the silicon substrate 83, wherein n-type impurities are doped. One of the impurity diffusion regions, 85a, is defined as a source S and the other, 85b, is defined as a drain D. Above the surface of the silicon substrate 83 between the two impurity diffusion regions 85a and 85b, a gate electrode 87 is formed. Between the gate electrode 87 and the surface of the silicon substrate 83, the gate insulation layer 86 is formed.

To the source S of the MOS type FET 82, the bottom of the ferromagnetic tunnel junction element 40, i.e., the underlayer shown in FIG. 1, is connected electrically. To the drain D, a plate line 88 is connected electrically. The gate electrode 87 is connected to a reading word line 89 electrically. The gate electrode 87 can double as the reading word line 89.

The ferromagnetic tunnel junction element 40, not illustrated in detail, has the same structure of the ferromagnetic tunnel junction element 40 shown in FIG. 1. The direction of the easy axis of magnetization can be oriented by heat treatment or shape anisotropy.

On the top of the ferromagnetic tunnel junction element 40, i.e., on the second cap layer 36 shown in FIG. 1A, a bit line 90 is connected electrically. To the top of the ferromagnetic tunnel junction element 40, the source S of the MOS type FET 82 is connected electrically as previously mentioned. Beneath the ferromagnetic tunnel junction element 40, a writing word line 91 is formed with a space.

The surface of the silicon substrate 83 and the gate electrode 87 of the magnetic memory device 80 are covered with an interlayer insulation 93 (e.g., a silicon nitride layer or a silicon oxide layer). The ferromagnetic tunnel junction element 40, the plate line 88, the reading word line 89, the bit line 90, the writing word line 91, a perpendicular wiring 94 and an interlayer wiring 95 are electrically insulated by the interlayer insulation 93 except the electrical connections above-mentioned.

Next, the writing/reading performance of the magnetic memory device will be discussed. The information writing onto the ferromagnetic tunnel junction element 40 of the magnetic memory device 80 is done by using the bit line 90 and the word line 91 formed over and under the ferromagnetic tunnel junction element 40. The bit line 90 stretches over the ferromagnetic tunnel junction element 40 in the X direction. When current is applied to the bit line 90, it flows into the ferromagnetic tunnel junction element 40 in the Y direction. The writing word line 91 stretches in the Y direction under the ferromagnetic tunnel junction element 40. When the current is applied to the writing word line 91, it flows into the ferromagnetic tunnel junction element 40 in the X direction.

The magnetizations of the first free layer and the second free layer of the ferromagnetic tunnel junction element 40 are held in the X direction (e.g., the X2 direction) and in stable state unless the magnetic field is substantially applied. Since the magnetic exchange-coupling occurs between the first free layer and the second free layer, their magnetizations are parallel. Hereinafter, unless otherwise indicated, “the magnetizations of the first free layer and the second free layer” will be simply stated as “magnetization of the multilayered free layers” for convenience.

In writing data onto the ferromagnetic tunnel junction element 40, the current is applied to both the bit line 90 and the writing word line 91 simultaneously. For instance, to toggle the magnetization direction of the multilayered free layers in the X direction, the current will be applied to the writing word line 91 in the Y direction, thereby orienting the magnetic field of the ferromagnetic tunnel junction element 40 in the X1 direction. The current applied to the bit line 90 can be in any of the X1 or X2 direction. The magnetic field generated in the ferromagnetic tunnel junction element 40 by applying the current to the bit line 90 is oriented to the Y1/Y2 direction, and acts as a part of the magnetic field for “switching” the magnetization direction of the multilayered free layers. In other words, the magnetization direction of the multilayered free layers in the X2 direction is flipped in the X1 direction by applying a magnetic field in X1 direction in conjunction with the current in Y1/Y2 direction. After removing the magnetic field, the magnetization direction of the multilayered free layers is held in the X1 direction and in the stable state unless the magnetic field for a next writing or an erasure is applied.

In this manner, “1s” or “0s” can be written onto the ferromagnetic tunnel junction element 40 according to the direction of the magnetization of the multilayered free layers. In short, where the direction of the magnetization of the pinned layers is held in the X1 direction—1's are indicated when the direction of the magnetization of the multilayered free layers is in the X1 direction (with a low tunnel resistance), 0's are indicated when the direction of the magnetization of the multilayered free layers is in the X2 direction (with a high tunnel resistance).

The reversal of the magnetization direction of the multilayered free layers is not caused when the current flows through either of the bit line 90 or the writing word line 91 alone. Thus, recording onto the ferromagnetic tunnel junction element 40 can be done only at a point where the bit line 90 with current and the writing word line 91 with current intersect.

Further, to prevent flow the current flow through the ferromagnetic tunnel junction element 40 when applying the current to the bit line 90 for writing, the neighborhood of the source S is set to a high impedance.

Reading information from the ferromagnetic tunnel junction element 40 of the magnetic memory device 80 is performed by applying a negative voltage to the source S through the bit line 90 and applying a voltage (positive voltage) higher than the threshold voltage of the MOS type FET 82 to the reading word line 89, i.e., the gate electrode 87. Thus the MOS type FET is turned on and electrons flows from the bit line 90, the ferromagnetic tunnel junction element 40, the source S, and then to the drains D through the plate line 88. With the amount of electron flow per unit time, i.e., the current value, the tunnel resistance value attributed to the ferromagnetic tunnel effect corresponding to the magnetization direction of the multilayered free layers can be detected. Thus the “1s-information” and “0s-information” stored in the ferromagnetic tunnel junction element 40 can be read.

The ferromagnetic tunnel junction element 40 has the high tunnel resistance change ratio as described with the first example. Since the difference between the tunnel resistance values corresponding to “0s” and “1s” in reading is great, the magnetic memory device 80 can read the information correctly. In addition to that, using ferromagnetic material having a high soft magnetic property (i.e., a low coercitivity) contributes to reduce the magnetic field to be applied in writing. Thus the current value applied to the bit line 90 and the writing word line 91 in writing can be reduced. Thereby the power consumption of the magnetic memory device 80 is reduced.

Further, for the magnetic memory device 80, the tunnel resistance change ratio of the ferromagnetic tunnel junction element 40 suffers less from the heat processing, so the magnetic memory device 80 is excellent in heat resistance. Therefore, in processing the magnetic memory device 80, this advantage helps to ease restriction on heating temperature applied to the substrate during a high heating processing, for instance during the, forming process of the interlayer insulation by the CVD method.

In this specification, the bit line 90 is connected to the protective layer of the ferromagnetic tunnel junction element 40 and the source S is connected to the underlayer, but the opposite connection can be available. Again, the structure of the magnetic memory device 80 is not limited to the one described above. The ferromagnetic tunnel junction element shown in FIG. 1 can be applied to a publically known magnetic memory device.

This invention is not limited to the examples described above. The examples are examples and examples of any form having substantially the same structure of the technical idea described within the scope of this invention and having the same effects are considered to be embraced in the technical scope of this invention.

### EXAMPLE 1

The element in the first example having the same structure of the ferromagnetic tunnel junction element shown in FIG. 1 is produced by the following manner.

Using a magnetron sputter device, the layered body shown in FIG. 3A is formed in the following manner: 1). The conductive layer 12 made of NiFe is formed on the Si substrate 10 covered with the SiO₂ layer. 2). The surface of the layered body is leveled by chemical mechanical polishing (CMP). 3). The surface of the conductive layer 12 is cleansed by Ar reverse sputtering. 4). A 5 nm thickness of the first underlayer 13 made of Ta is formed on the conductive layer 12. Then, 5). A 2 nm thickness of the second underlayer 14 made of Re is formed, followed by 6). A 7 nm thickness of the pinning layer 18 made of Ir₂₁Mn₇₉, 7). A 2 nm thickness of the first pinned layer 20 made of Co₇₄Fe_{26.8}). 8). A 0.8 nm thickness of the nonmagnetic junction layer 21 made of Ru, 9). A 2 nm thickness of the second pinned layer 22 made of CO₆₀Fe₂₀B₂₀, 10). A 1.0 nm thickness of the insulation layer 25 made of MgO, 11). A 2 nm thickness of the first free layer 30 made of Co₆₀Fe₂₀B₂₀, 12). A 4 nm thickness of the second free layer 32 made of Ni₇₂Fe₈B₂₀, 13). A 5 nm thickness of the first cap layer 35 made of Ta, 14). A 10 nm thickness of the second cap layer made of Ru. These layers are formed from bottom to top.

Then the vacuum heat treatment is conducted for 5 hours at 280 degree C. by applying a magnetic field. Thereafter, as shown in FIG. 3B, the columnar ferromagnetic tunnel junction element 40 is formed by patterning from the first underlayer 13 through the second cap layer 36 in the circular form 0.6 μmφ in diameter. For patterning these layers, Ar ion milling is used. Thereafter, the insulation layer 48 composed of silicon oxide is formed by the RF sputterer, the first electrode 45 made of Au is formed by the RF sputterer, the via hole penetrated through the insulation layer 48 is formed by dry etching, the second electrode 46 made of Au is formed by the RF sputter—to obtain the layered body as shown in FIG. 1A.

### EXAMPLE 2

The ferromagnetic tunnel junction element in the second example is formed in the same manner of the first example except: making the first free layer 30 (2 nm) of Co₇₁Fe₂₄B₅ instead of Co₆₀Fe₂₀B₂₀, and making the second free layer 32 (4 nm) of Ni_{85.5}Fe_{9.5}B₅ instead of Ni₇₂Fe₈B₂₀.

### EXAMPLE 3

The ferromagnetic tunnel junction element in the third example is formed in the same manner of the first example except: making the first free layer 30 (2 nm) of Co_{67.5}Fe_{22.5}B₁₀ instead of CO₆₀Fe₂₀B₂₀, and making the second free layer 32 (4 nm) of Ni₈₁Fe₉B₁₀ instead of Ni₇₂Fe₈B₂₀.

### EXAMPLE 4

The ferromagnetic tunnel junction element in the fourth example is formed in the same manner of the first example except: making the first free layer 30 (2 nm ) of Co_{63.7}Fe_{21.3}B₁₅ instead of Co₆₀Fe₂₀B₂₀, and making the second free layer 32 (4 nm) of Ni_{76.5}Fe_{8.5}B₁₅ instead of Ni₇₂Fe₈B₂₀.

### EXAMPLE 5

The ferromagnetic tunnel junction element in the fifth example is formed in the same manner of the first example except: making the first free layer 30 (2 nm ) of Co_{56.2}Fe_{18.8}B₂₅ instead of Co₆₀Fe₂₀B₂₀, and making the second free layer 32 (4 nm) of Ni_{67.5}Fe_{7.5}B₂₅ instead of Ni₇₂Fe₈B₂₀.

### COMPARATIVE EXAMPLE 1

The ferromagnetic tunnel junction element in the first comparative example is formed in the same manner of the first example except: making the first free layer 30 (2 nm) of Co₇₄Fe₂₆ instead of Co₆₀Fe₂₀B₂₀, and making the second free layer 32 (4 nm) of Ni₉₀Fe₁₀ instead of Ni₇₂Fe₈B₂₀.

### COMPARATIVE EXAMPLE 2

The ferromagnetic tunnel junction element in the second comparative example is formed in the same manner of the first example except: making the second free layer 32 (4 nm) of Ni₉₀Fe₁₀ instead of Ni₇₂Fe₈B₂₀.

Evaluation

The MR ratio and the coercitivity (Hc) of the tunnel junction element obtained from the examples 1-5 and the comparative examples 1 and 2 are evaluated as follows.

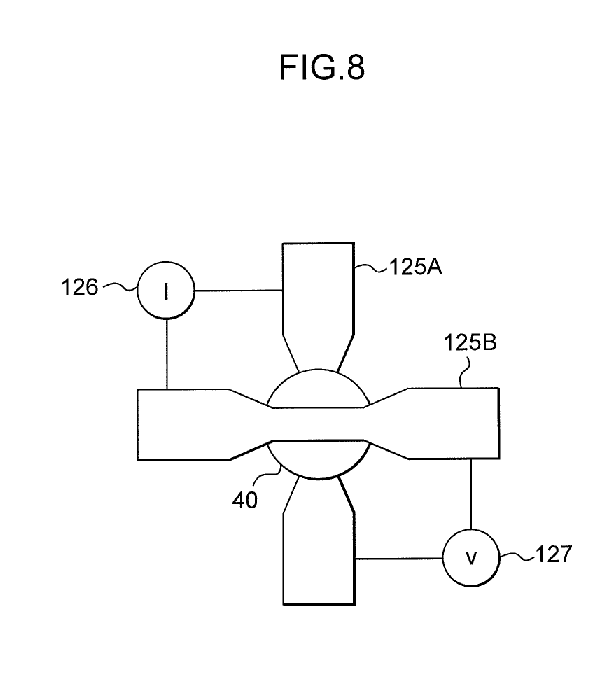

The MR ratio is measured as follows. FIG. 8 illustrates the measuring method of the MR ratio. As shown in FIG. 8, the lower electrode 125A and the upper electrode 125B are formed to sandwich the ferromagnetic tunnel junction element 40. The lower electrode 125A is connected to the underlayer 13 electrically and the upper electrode 125B is connected to the second cap layer 36 electrically as per FIG. 1. The lower electrode 125A and the upper electrode 125B are connected through a DC current source 126 to apply 0.1 mA of sense current in a perpendicular direction to the surface of the ferromagnetic tunnel junction element 40. Then the magnetic field is applied parallel to the magnetization direction of the second pinned layer, and then the magnetic field is changed within a range from −79 to +79 kA/m in intensity, measuring voltage changes between the lower electrode 125A and the upper electrode 125B by a digital voltage meter 127. Thereafter, the resistance value is derived from the voltage value obtained. The tunnel resistance value derived when the magnetizations of the second pinned layer and the first free layer are parallel is defined as Rs, a difference between a tunnel resistance value derived from the case where the magnetization direction of the second pinned layer and the first free layer are parallel and a tunnel resistance value derived from the case where the magnetization direction of the second pinned layer and the first free layer are anti-parallel is defined as ΔR, and the MR ratio is defined as ΔR/Rs. All values of the tunnel resistance Rs derived from the the examples and comparative examples are 3Ωμm². The coercitivity is derived from the magnetic field wherein the difference between the tunnel resistance values ΔR halves.

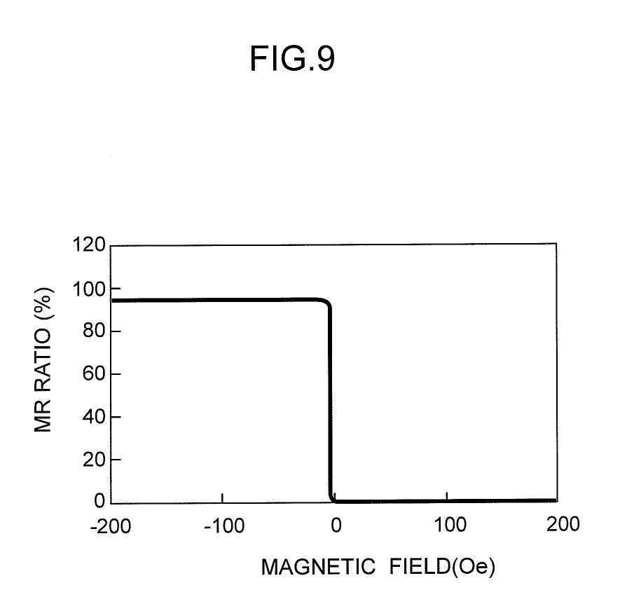

FIG. 9 shows the representative magnetoresistive curve of the ferromagnetic tunnel junction element in the first example. Table 1 shows evaluation results of the ferromagnetic tunnel junction element in the first example and the first/second comparative examples.

TABLE 1

| | | Comparative | Comparative |
|---|---|---|---|
| | Example 1 | Example 1 | Example 1 |
| First free layer/ | CoFeB/ | CoFe/ | CoFeB/ |
| Second free layer | NiFeB | NiFe | NiFe |
| MR ratio at 3 Ωμm² | 95 | 55 | 42 |
| (%) | | | |
| Hc (Oe) | 3.8 | 1.9 | 4.6 |

For the ferromagnetic tunnel junction elements in the first/second comparative examples, NiFe having a high soft magnetic property is used for the second free layers. Thus the coercivities of both of them are low. However, the MR ratios are insufficiently low, less than 60%. The ferromagnetic tunnel junction element in the first example where NiFeB is used for the second free layer, has a relatively low coercitivity compared with the comparative examples, and the MR ratio is relatively high.

The MR ratios of the tunnel junction elements obtained in the examples 2-5 are evaluated in the same manner of the first example. Table 2 shows evaluation results of the examples 1-5.

TABLE 2

| | Example | | | | |
|---|---|---|---|---|---|
| | 2 | 3 | 4 | 1 | 5 |
| B (atom %) | 5 | 10 | 15 | 20 | 25 |
| MR ratio (%) | 43 | 76 | 97 | 95 | 82 |

The MR ratios of the examples 1-5, using NiFeB for their second free layers, are higher compared to the second comparative example wherein NiFe is used for the second free layer. Where the concentration of boron atoms is within a range of 10-25 at %, the MR ratio is preferable, 60%. Particularly, the MR ratio is highly preferred where the concentration of boron atoms is 15 at % or 20 at %.

What is claimed is:

1. A ferromagnetic tunnel junction element, comprising:
a pinned layer wherein at least a part of a magnetization direction is held;
an insulation layer formed on the pinned layer, creating an energy barrier that electrons can flow through by a tunnel effect;
a first free layer formed on the insulation layer made of a first ferromagnetic material containing boron atoms, wherein a direction of the magnetization switches under an influence of an external magnetic field; and
a second free layer made of a second ferromagnetic material containing boron atoms formed on the first free layer, wherein the direction of the magnetization switches under the influence of the external magnetic field, exchanging and coupling with the first free layer.

2. The ferromagnetic tunnel junction element according to claim 1, wherein the second ferromagnetic material is amorphous.

3. The ferromagnetic tunnel junction element according to claim 1, wherein the second ferromagnetic material contains 10-25 at % of boron atoms.

4. The ferromagnetic tunnel junction element according to claim 1, wherein the first ferromagnetic material contains 10-25 at % of boron atoms.

5. The ferromagnetic tunnel junction element according to claim 1, wherein the first ferromagnetic material contains Co atoms and Fe atoms.

6. The ferromagnetic tunnel junction element according to claim 1, wherein a coercitivity of the second free layer is lower than that of the first free layer.

7. The ferromagnetic tunnel junction element according to claim 1, wherein the ferromagnetic material contains Ni atoms and Fe atoms.

8. The ferromagnetic tunnel junction element according to claim 7, wherein a proportion of the Ni atoms to Fe atoms is 85 at % of greater.

9. The ferromagnetic tunnel junction element according to claim 1, wherein the insulation layer is crystalline.

10. The ferromagnetic tunnel junction element according to claim 1, wherein the insulation layer contains magnesia oxide partially crystallized.

11. A magnetic recording device comprising:
a magnetic recording medium for information recording/reproduction; and
a head slider for recording/reproducing information onto/from the magnetic recording medium, laid out against the magnetic recording medium,
wherein the head slider comprises;
a magnetic head having a pinned layer in which at least a part of the magnetization direction is held in one specific direction;
an insulation layer formed on the pinned layer, creating an energy barrier that electrons can flow through by the tunnel effect;
a first free layer formed on the insulation layer, wherein the direction of the magnetization switches under the influence of the external magnetic field, made of a first ferromagnetic material containing boron atoms;
a tunnel junction element having a second free layer made of a second ferromagnetic material containing boron atoms formed on the first free layer, wherein the direction of the magnetization switches under the influence of an external magnetic field, exchanging and coupling with the first free layer, made of the second ferromagnetic material containing boron atoms.

12. A magnetic memory device comprising:
a pinned layer wherein at least a part of a magnetization direction is held in one specific direction;
an insulation layer formed on the pinned layer, creating an energy barrier that electrons can flow through by the tunnel effect;
a first free layer formed on the insulation layer made of a first ferromagnetic material containing boron atoms, wherein the direction of the magnetization switches under the influence of the external magnetic field;
the ferromagnetic tunnel junction element having a second free layer formed on the first free layer made of a second ferromagnetic material containing boron atoms, wherein the direction of the magnetization switches under the influence of the external magnetic field, exchanging and coupling with the first free layer, a writing means for applying a magnetic field to the ferromagnetic tunnel junction element to switch the directions of the magnetizations of the first and second free layers in specific directions; and
a reading means for detecting a tunnel resistance value by applying a sense current to the ferromagnetic tunnel junction element.
